(19) United States
(12) Patent Application Publication
(10) Pub. No.: US 2023/0405866 A1
(43) Pub. Date: Dec. 21, 2023

(54) Process and Design Modifications to Retrofit a Conventional Wood Plant

(71) Applicant: T2Earth Holdings, LLC, Woodbury, NY (US)

(72) Inventors: Joel Kier, New York, NY (US); Roland Fritsch, Evans, GA (US); Kurt Malzer, Grovetown, GA (US); Levi Anderson Pollard, V, Appling, GA (US); Leondra May, Evans, GA (US)

(21) Appl. No.: 18/210,448

(22) Filed: Jun. 15, 2023

Related U.S. Application Data
(60) Provisional application No. 63/352,899, filed on Jun. 16, 2022.

(51) Int. Cl. B27K 3/10; B27K 3/20

(52) U.S. Cl. CPC B27K 3/10; B27K 3/20; B27K 3/025

(57) ABSTRACT

A transformation of an existing, conventional southern yellow pine (SYP) lumber pressure treatment plant that previously impregnated wood with non-sustainable chemicals, to using environmentally friendly sodium silicate formulations. The transformation may include adding heated storage tanks for solutions of siliceous solutions and adding a heater to an existing storage tank, installing delivery lines capable of handling high pH, viscous solutions between at least the pre-existing vacuum pressure impregnation tank and the added or existing heated storage tank, a CO₂ storage tank with associated vaporizer and a CO₂ recovery system, associated lines to and from the pre-existing vacuum pressure impregnation tank and the CO₂ storage tank and the CO₂ recovery system, pumps for circulating the solutions, and a thermal management system including: insulation and cladding on one or more of the tanks and lines, heat tracing on all level indicators; and insertion of heating coils in working tanks.

### CROSS REFERENCE

This is a U.S. nonprovisional Application claiming priority on Application No. 63/352,899 filed Jun. 16, 2022, the content of which is incorporated herein by reference.

### FIELD OF THE INVENTION

This present disclosure relates to transforming an existing, conventional southern pine (SYP) wood pressure treatment plant that previously impregnated wood with non-sustainable chemicals, such as CA (copper azole), CCA (chromated copper arsenate), and ACQ (alkaline copper quaternary) into a plant to treat wood with environmentally friendly sodium silicate formulations or other sustainable formulations. Wood means dimensional lumber, plywood, engineered wood such as LVL (laminated veneer lumber), OSB (oriented strand board) and mass timber, including CLT (cross laminated timber), and related products.

### DISCUSSION OF RELATED ART

Wood is one of the oldest building materials used in human civilization due to its strength, availability, and performance characteristics. Despite these characteristics, wood suffers if exposed to prolonged wet conditions and due to its poor resistance to insect, fungal, and other biological attacks. As a result of this susceptibility, treatments are applied to wood to improve its durability to insects, fire retardancy, and environment conditions. These treatments have traditionally been in the form of metal or other environmentally unfriendly chemicals, such as CA (copper azole), CCA (chromated copper arsenate), and ACQ (alkaline copper quaternary), and in the case of fire retardancy enhancements, OPFR (organophosphorus flame retardants), and chemicals such as ammonium phosphate and ammonium borate.

FIG. 3 shows a traditional lumber pressure treatment plant used in a traditional treatment process. The traditional wood pressure treatment plant impregnates conventional southern pine (SYP) lumber wood and plywood with non-sustainable chemicals. The plant comprises a timber receiving area 310 where the lumber and plywood is received. Preferably, the timber, plywood, or related forest products is received in standard dimensional lumber size and no further milling or sawing is required. Alternatively, there is a subsequent milling or sawing step after the lumber or plywood is received. A first processing occurs at a vacuum pressure impregnation vessel 320. Impregnation vessel 320 is also commonly referred to as a reactor or autoclave. After the vacuum pressure impregnation, the lumber is moved to a storage and acclimation area 330. The next area is a kiln 340 where the lumber is dried. The lumber is moved by a tilt hoist 350, which is a device for lifting wood by tilting the stack and lifting it. After the lumber is dried, the lumber is labeled and packaged at a label and packaging station 360 and sent to a storage area 370 for storage and shipping.

Plywood is processed in a similar manner in which plywood panels in bundles would flow on conveyors or moved by fork lifts to an autoclave. After processing in the autoclave, the plywood is transferred to a drying kiln, and then to labeling, packaging, and shipping.

### SUMMARY OF THE DISCLOSURE

The process of impregnating non-sustainable chemicals such as chromated copper arsenate is a standard practice in the wood industry. The chemical formulations are fluids that are low in viscosity and readily absorbed into the wood and, as such, the manufacturing process used for them requires a less demanding application process than the process applications describe below for sodium silicate (Na₂O)x·SiO₂ and related metal silicate based solutions. Thus, to adjust an existing wood processing plant reactor to the demands of sodium silicate solutions requires processing equipment that can handle a polar, caustic, aqueous solution that may possess some non-Newtonian characteristics to impregnate the wood. A further distinction in the sustainable process using sodium silicate is that the sodium silicate must be cured to form a cohesive solid and this is accomplished by CO₂ delivery to lower the pH of the impregnated solution, or another suitable method, to below about 9.

There is a need to transform an existing lumber pressure treatment plant to a cost-efficient, environmentally-friendly, i.e. all-green plant for treating wood that can eliminate toxic chemicals and provide enhancing strength properties, increased fire resistance ratings that meet or exceed current international and domestic recognized building and building materials standards, while maintaining other desirable properties such as resistance to rot, bacteria, and insects while also providing other desired properties without using toxic chemicals. The transformed lumber treatment plant is capable of treating wood according to the methods disclosed in U.S. Patent Publication 2021/0170623 entitled Green Process for Modifying Wood, the content of which is incorporated by reference.

The method for processing timber begins with the insertion of kiln strips into lumber packets. Alternatively, the method is performed without inserting kiln strips in the lumber packets. Next, the lumber packets are strapped and, then the impregnation process can begin in the autoclave. Once the lumber is inserted into the autoclave, the autoclave is placed under vacuum. According to one aspect of the invention, the vacuum is −28 to −30 psi for about 30 minutes. Other vacuums can be drawn between −15 psi and −50 psi. The process chemicals disclosed in the aforementioned patent publication are next inserted into the autoclave for a requisite time at an elevated pressure and elevated temperature. Next a vacuum is again drawn on the wood in the autoclave, which is then filled with carbon dioxide and allowed to remain under pressure for periods of time ranging from 20 minutes to 24 hours. The reactor is unheated. However, the silicate solution is preheated to 60-70° C., although a broader temperature range between 50-80° C. can be used. The solution once introduced is then pressurized at 190 psi for 90 min, followed by vacuum at −28 psi for about 5 minutes, completing with pressurization to 50 psi for 20-30 min. While these ranges are exemplary, a broader range is conceivable. The carbon dioxide is then removed by, again, placing the autoclave under vacuum. Once the vacuum is released, the lumber is removed from the autoclave and allowed to dry for 24 to 48 hours. The lumber is then reinserted into the autoclave. A vacuum is drawn and the process chemicals are injected into the autoclave for a second time at elevated pressure and elevated temperature. The chemicals are then removed by drawing a vacuum on the autoclave, and may be followed by a second treatment with CO₂ or alternatively removed from the autoclave and kiln dried at about 50° C. for a period of five to seven days. It should be noted that the temperature and cycle times may vary depending on environment conditions, load sizes, wood sizes, at the time of drying. After drying, the kiln strips are removed and the lumber is brushed and stamped. The brushed and stamped lumber is then ready for sale to market.

This disclosure presents a cost-effective solution to transform or repurpose existing lumber processing plants by making novel technical changes to pre-existing plants. Not only is this cost effective, but once the reactors have been thoroughly cleaned and modified, a potentially hazardous waste condition at existing plants can be eliminated.

The wood pressure treatment plant is configured to perform a wood vacuum-pressure impregnation process. The plant to be modified has a pre-existing vacuum pressure impregnation tank, feed lines, vacuum pump(s), and a wood transport system. At least the following additions and modifications are made to the existing plant for non-toxic and environmentally sustainable processing:
Installing, if not already present, an autoclave capable of handling a siliceous solution pressurized at approximately 190 psi;
adding one or more heated storage tanks for solutions of siliceous solutions;
adding and/or replacing delivery lines with delivery lines capable of handling high pH, viscous solutions at elevated temperatures;
adding one or more CO₂ storage tank(s) each with an associated vaporizer and delivery lines;
a CO₂ recovery system;
one or more pumps and filter pumps capable of handling high pH, viscous solutions; and
a thermal management system comprising insulation and cladding on all vessels and, where feasible, on the delivery lines, temperature tracing, level indicators, which are typically magnetic float type indicators, and heating coils that are inserted in working tanks.

According to one aspect of the invention, a process control information system is installed that is configured to manage, monitor, and record the wood vacuum pressure impregnation process and other related processes. The process control information system is further configured to optimize key performance indicators including, silicate solution temperatures, autoclave pressures, and vacuum, pressurization and carbon dioxide cycles durations.

According to one aspect of the invention, software is added to an existing or upgraded Programmable Logic Controller (PLC) system to function in conjunction with digital and mechanical recording devices to track, record, and analyze the process variables in real time for sodium silicate solutions. The process variables include solution temperature, autoclave pressure, amounts of solution utilized, storage tanks and treatment autoclave temperatures, duration of each stage of the process, and correlations between these variables. The software provides the collected data that can be used to further optimize the process.

The sodium silicate solutions require processing equipment that can handle a polar, caustic, aqueous solution that may possess some non-Newtonian characteristics to impregnate the wood.

According to one aspect of the invention, the pH of the silicate solution is typically between 10-12.

According to one aspect of the invention, the insulation, which is the material that prevents heat loss and serves as the actual thermal insulator, is typically fiberglass, and the cladding is a protective coating over the insulator, typically a corrugated metal.

According to one aspect of the invention, the components are added so that a two-step impregnation process can be performed.

According to one aspect of the invention, one or more kilns are installed that are in-line kilns for drying the silicate impregnated wood.

According to one aspect of the invention, an in-line machine stress measurement system is added for the lumber following the impregnation step for silicate uptake quantification. There are several alternatives to implement the stress measurement system. A first alternative is a device configured to measure density of wood by removing a small sample and plotting density. An example would include a drill and related components typically used to test poles and related structures. A second alternative is an industrial scale lumber strength measuring device that uses X-ray and other imaging technology to assess lumber. This device can determine density of both finished product and to grade incoming lumber to preferentially shift lower density wood for impregnation. This device can also perform natural frequency analysis. Another alternative would be a system that uses sound transmission, which is generally used to assess tree health. Such a system can be adapted to analyze the filled silicate composites because the silicate filler will change the density of the wood and could be measured by this technique non-destructively. Additionally, or alternatively, bending stress measurements can be used.

According to one aspect of the invention, a hyper-spectral analyzer system, an x-ray analyzer, or acoustic analyzer system is added so that the lumber can be analyzed for wood morphology analysis both before and after impregnation. Hyperspectral analysis measures spectroscopic data across a variety of wavelengths, typically in the near infrared for wood, to determine a surface composition of the product.

According to one aspect of the invention, a natural frequency measurement system is added for silicate uptake quantification. Natural frequency is a characteristic vibration mode of a material. It is obtained in much the same manner that one would use to get a tuning fork to resonate. The wood beam is struck and the resulting frequency is measured.

According to one aspect of the invention, a multi-input solution dispensing system is added upstream of the feed lines into the impregnation tank(s) for formulation control and quantification, which are capable of delivering two or more impregnation charges.

According to one aspect of the invention a spray and/or an immersion delivery system is included that is configured to dispense aqueous solutions including solutions that are high, neutral, and low pH, both before and after impregnation steps. The continuous spray setup would include a conveyor or the like and the wood would pass under a plurality of spray heads to treat the wood. An immersion delivery system would include a tank into which the wood would be immersed.

According to one aspect of the invention software is used in the facility to work with digital and mechanical recording devices programmed to track, record, and analyze the key process variables in real time including solution temperature, autoclave pressure, amounts of solution utilized, storage tanks and treatment autoclave temperatures, duration of each stage of the process and correlations between these variables.

### BRIEF DESCRIPTION OF FIGURES

The invention will be described in more detail on the basis of an exemplary embodiment. In the figures:

FIG. 1 is a flow chart showing an exemplary implementation of a wood treatment process;

FIG. 2 is a schematic layout for a transformed lumber processing plant for the wood modification process of FIG. 1;

FIG. 3 is a schematic layout for an existing lumber processing plant;

FIG. 4 is an exemplary agitator;

FIGS. 5A and 5B show a tank with an agitator; and

FIG. 6 is a flowchart for transforming a treatment plant.

### DETAILED DESCRIPTION OF THE FIGURES

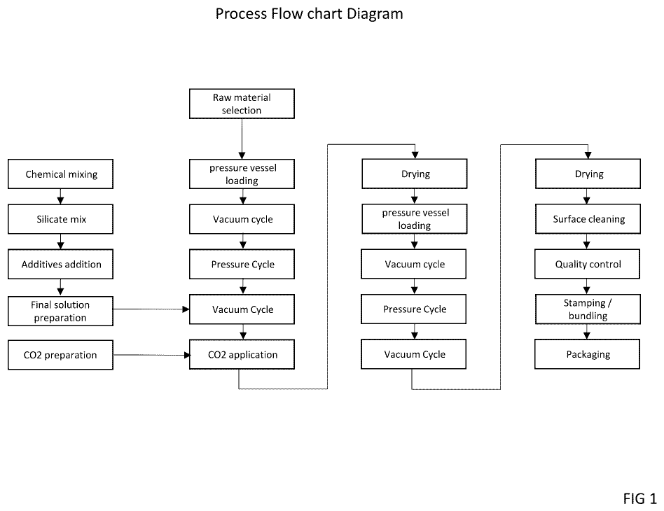

A transformed southern pine wood pressure treatment plant uses a non-toxic and environmentally sustainable process for modifying wood using sodium silicate formulations or other environmentally friendly formulations. An exemplary implementation of the treatment process is shown in FIG. 1. The impregnation liquid is prepared by mixing a silicate mix with water in a feed tank. Optionally, boric acid, sodium borate, sodium hydroxide or other impregnation efficiency inducing compounds including surface acting agents may be added to this feed tank. The last solution preparation can include multiple additives for treatment. The mixture can be pumped to a working tank for heating and agitation. Once a size of lumber is selected, the untreated lumber is placed in an impregnation vessel/autoclave. The autoclave is placed under vacuum and then the liquid mixture from the working tank is added to the impregnation vessel/autoclave. Once the liquid mixture is added, pressure is applied to the autoclave. Next, pressure is reduced and the impregnation vessel/autoclave is placed under vacuum. Optionally, a second impregnation step is included that involves addition of a second, typically higher concentration of impregnating solution to the autoclave. After the impregnation vessel/autoclave is placed under vacuum, gaseous carbon dioxide from carbon dioxide processing apparatus is introduced into the impregnation vessel/autoclave. Next, the treated lumber is removed from the impregnation vessel/autoclave.

According to one aspect on the invention, certain quality control testing is performed to evaluate the treatment process. These processes are developed and customized to know if the impregnation has been successful. The treated lumber is then heated and dried using a conventional sawmill kiln.

According to one aspect of the invention, a second impregnation process is performed. This second impregnation can be performed in the same equipment or using additional processing equipment. The once-treated lumber is loaded into the pressure vessel where it undergoes vacuum, pressure, and vacuum cycles. The lumber is then dried a second time.

A surface cleaning is performed on the treated lumber. Next, the treated lumber can undergo a quality control analysis. The treated lumber is then stamped, bundled, and packaged for shipping.

To perform the impregnation process above, an existing, conventional southern pine (SYP) lumber pressure treatment plant has to be modified. A conventional lumber pressure treatment plant typically includes a lumber infeed chain, a chemical storage system, a water storage system, a treatment chemical blending tank, a feed product tank, an autoclave where the lumber impregnation takes place, and a drip tray for product draining.

Preferably, the conventional equipment for the conventional treatment process is used for the upgrades and modifications. Alternatively, the conventional equipment can be replaced.

A large product delivery tanker offloading station, with associated piping is added. The new or existing chemical storage tank(s) are insulated with insulating material and cladded with a protective material. Insulation and cladding is also added to the feed line(s) between the storage tank and the blending tank, to the blending tank, and to the product feed line(s) to and from the working tank and to and from the autoclave.

According to one aspect of the invention, to heat the product a heating coil is installed in each of the working tanks. The heating coils are preferably horizontal coils inserted in the vessels. Heat tracing of the level indicators are added or upgraded for each of the working tanks, the blending tank, the autoclave, and the chemical feed tank. The change or addition of the heat tracing components is a precaution because typical level indicators are magnetic float indicators, which would be impacted by the higher viscosity chemical solution.

According to one aspect of the invention, an updated tote system for adding specialty chemicals to the main blending tank is installed. Totes are large plastic containers that hold liquids. In operation, a feedline is inserted into a tote and the liquid pumped out of the tote. Furthermore, a digitally controlled chemical feeder system can be installed and used to accomplish the specialty chemicals blending more precisely and efficiently.

The pumps and filters in the conventional plant are also upgraded. The pumps circulate treatment solution between storage tanks and treatment vessels as well as circulate treatment solution within the tanks and vessels. The enhanced pump is configured to pump the higher viscosity chemical solution to the working tanks. The pumps preferably use a filter sock type filter. According to one aspect of the invention, the filter medium is a 200 micron sock.

A carbon dioxide storage tank and associated vaporizer are installed, with a feed and return line to the autoclave. In addition, one or more double plug block valves with actuators are installed in these two lines.

According to one aspect of the invention, the piping in the conventional factory is rerouted to allow unimpeded flow of the higher viscosity silicate solutions. This re-routing may vary depending on the specific design of the existing plant, but should have as a priority removing flow constrictions, introducing unnecessary turbulence, and be as direct as possible.

The existing plant piping preferably remains intact, but changes are made to the working tank filter and pump system as noted above. In addition, all piping is insulated and clad to keep heat losses to a minimum to accommodate the operating temperatures of 50° C. to 100° C.

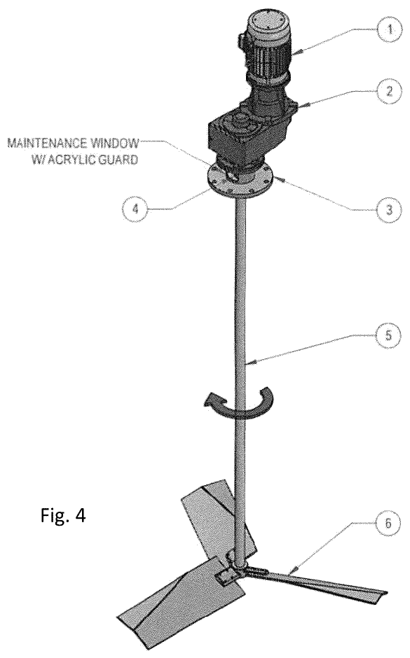

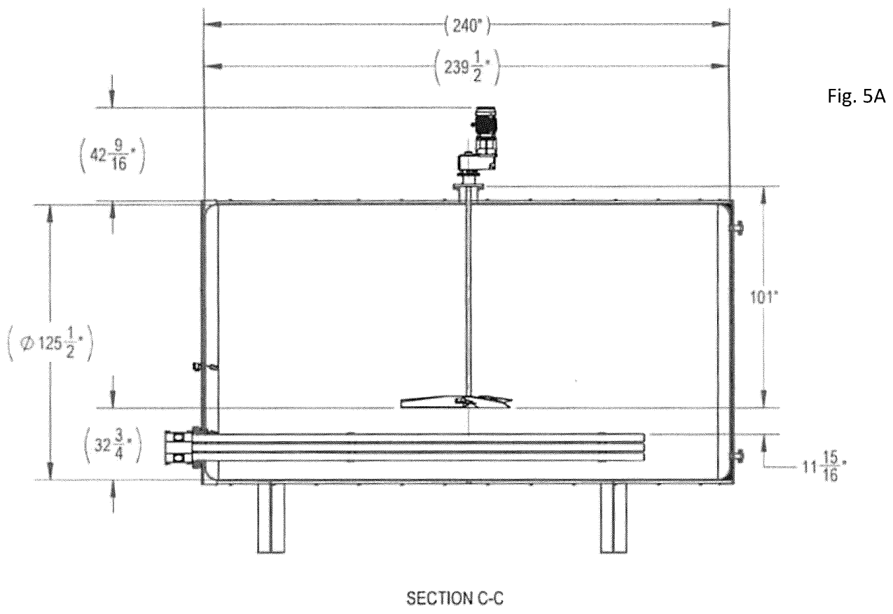

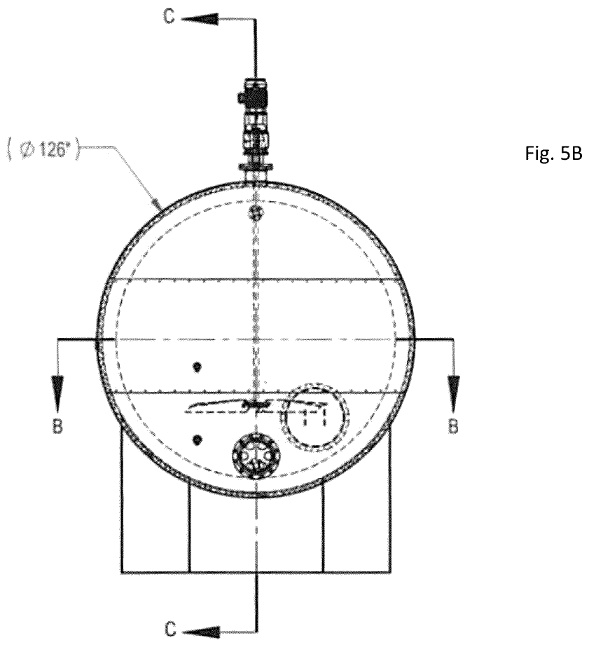

Agitation equipment is installed in the product working tanks. An exemplary agitator is shown in FIG. 4. The agitator comprises a motor 1, gearbox 2, seal assembly 3,4, drive shaft 5, and impeller 6. The impeller is driven clockwise as shown. FIGS. 5A and 5B show a tank with the agitator installed. Preferably, the agitators are large, paddle type agitators that provide a homogenous chemical product mix. The agitation and pump recirculation system provides a well-mixed formulation for the impregnation step.

To maintain the operating temperatures, heating coils are added as well as insulation and cladding, as discussed above. The heating coils maintain the chemical mixture, referred to as the product, at a temperature of approx. 50-95° C. While some steps in the impregnation systems may use chemicals at room temperature, the steps that require heated chemicals are more energy efficient when thermal insulation is provided, thus providing more consistent process results, and reduce product material losses.

Carbon dioxide gas is used in the process for the precipitation of the chemical added to the wood, through the lowering of the pH. Therefore, a CO₂ gas storage delivery and recovery system is installed. A liquid carbon dioxide storage vessel is installed, along with the requisite vaporizer. A two inch piping system is installed and fed into a rear top area of the autoclave as well as a return vent line.

According to one aspect of the invention, upgrades to the plant programmable logic controller (PLC) system are also installed. The existing PLC control system can be used but must be upgraded with logic changes and the addition of the new control loops, as well as appropriate software upgrades. The upgrades are provided at least in part in the temperature indication and control system. This upgrade is important for steady state operation where multiple impregnation cycles are taking place. The addition of fresh chemicals to the process on an ongoing basis requires a fast heater response and this logic is provided by the upgraded PLC.

According to one aspect of the invention software is added to the Programmable Logic Controller (PLC) system to function in conjunction with digital and mechanical recording devices programmed to track, record, and analyze the key process variables in real time. The process variables include solution temperature, autoclave pressure, amounts of solution utilized, storage tanks and treatment autoclave temperatures, duration of each stage of the process and correlations between these variables. The collected data can be used to further optimize the process.

In a conventional treatment process, the lumber is stacked in “packets” with one layer on top another. For the modified plant and process kiln strips are inserted prior to the treatment process. The kiln strips achieve two objectives. First, the kiln strips ensure that the lumber is well impregnated by providing space between layers. Second, the kiln strips allow the product to be kiln dried to reach the KD19 standard (Kiln-Dried to 19% moisture content).

This modified process using kiln strips comprises receiving wood, inserting kiln strips, strapping lumber packets, performing a one or two step impregnation operation, kiln drying the material, breaking down the packets and removing the kiln strips, and preparing final lumber packets for dispatch.

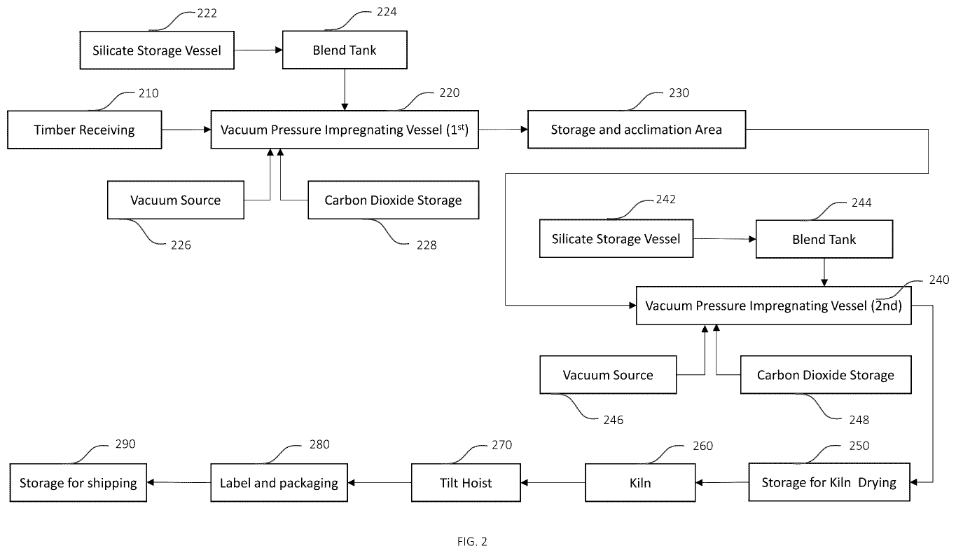

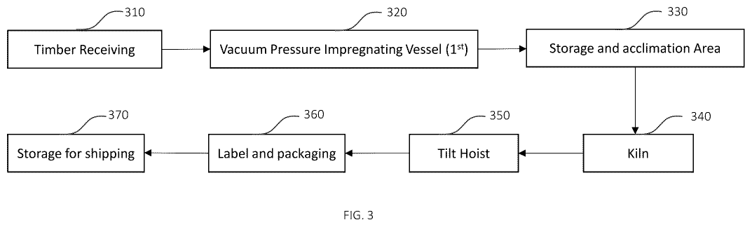

FIG. 2 is a schematic process layout for a transformed wood processing plant for the wood treatment process of FIG. 1. The wood processing plant has a timber receiving section 210, which may be the same or different than the storage and shipping area 290. The transformed wood processing plant includes one, two, or more vacuum pressure impregnation vessels 220, 240. If space permits, two or more vacuum pressure impregnation vessels 220, 240 are installed.

The first pressure impregnation vessel 220 is coupled to a silicate storage vessel 222 via a blend tank 224. There is also a vacuum source 226 and carbon dioxide storage 228 coupled to the first pressure impregnation vessel 220. A storage and acclimation area 230 is provided for the lumber that is processed in the first pressure impregnation vessel 220.

The second pressure impregnation vessel 240 is coupled to a silicate storage vessel 242 via a blend tank 244. There is also a vacuum source 246 and carbon dioxide storage 248 coupled to the first pressure impregnation vessel 240. It should be noted that the vacuum source 226 can be the same as the vacuum source 246. Further, the carbon dioxide storage 228 can be the same as the carbon dioxide storage 248. Piping can be provided so that only a single vacuum source and/or carbon dioxide storage is required.

A storage for kiln drying 250 is provided for the kiln 260 in which the processed lumber is dried. Tilt hoist 270 is used to lift and tilt the lumber. A label and packaging station 280 is provided as well as a storage area 290 for shipping. As previously mentioned, the storage area 290 can be the same or different than the timber receiving area 210.

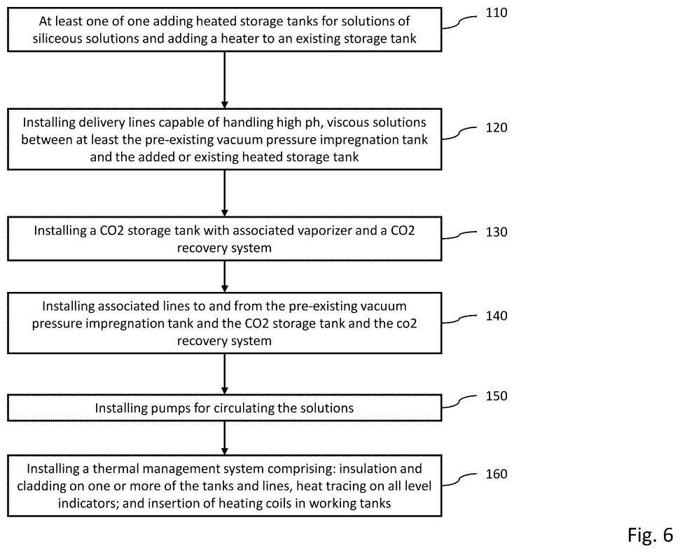

FIG. 6 is an overview of the steps to transform and/or update a treatment plant. The steps can be performed in any order but are presented in accordance with one aspect of the invention. At step 110, heated storage tanks for solutions of siliceous solutions are added and/or a heater is added to an existing storage tank. Delivery lines capable of handling high ph, viscous solutions are installed between at least the pre-existing vacuum pressure impregnation tank and the added or existing heated storage tanks at step 120. At step 130, a CO₂ storage tank with associated vaporizer and a CO₂ recovery system is added. At step 140, associated lines to and from the pre-existing vacuum pressure impregnation tank and the CO₂ storage tank and the CO₂ recovery system are installed. Pumps are then installed for circulating the solutions at step 150. Finally, at step 160, a thermal management system is installed that includes one or more of: insulation and cladding on one or more of the tanks and lines, heat tracing on all level indicators; and insertion of heating coils in working tanks.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method of upgrading a lumber vacuum-pressure impregnation process plant having a pre-existing vacuum pressure impregnation tank, feed lines, an original vacuum pump, and a lumber transport system, comprising:
at least one of adding heated storage tanks for solutions of siliceous solutions and adding a heater to an existing storage tank;
installing delivery lines capable of handling high pH, viscous solutions between at least the pre-existing vacuum pressure impregnation tank and the added or an existing heated storage tank;
installing a CO₂ storage tank with associated vaporizer and a CO₂ recovery system;
installing associated lines to and from the pre-existing vacuum pressure impregnation tank and the CO₂ storage tank and the CO₂ recovery system;
installing pumps for circulating the solutions; and
installing a thermal management system comprising:
insulation and cladding on one or more of the tanks and lines;
heat tracing on all level indicators; and
insertion of heating coils in working tanks.

2. The method of upgrading the lumber vacuum-pressure impregnation process plant in claim 1, further comprising:
installing a second vacuum pressure impregnation tank and associated feed lines.

3. The method of upgrading the lumber vacuum-pressure impregnation process plant in claim 2, further comprising:
upgrading or replacing, the pre-existing vacuum-pressure impregnation tank for the impregnation process for silicate impregnated wood.

4. The method of upgrading the lumber vacuum-pressure impregnation process plant in claim 1, further comprising:
installing an in-line kiln for drying silicate impregnated wood.

5. The method of upgrading the lumber vacuum-pressure impregnation process plant in claim 1, further comprising:
installing an in-line machine stress measurement system that quantifies silicate uptake.

6. The method of upgrading the lumber vacuum-pressure impregnation process plant in claim 1, further comprising:
installing a hyper-spectral analyzer, an x-ray analyzer, or acoustic analyzer system for wood morphology analysis.

7. The method of upgrading the lumber vacuum-pressure impregnation process plant in claim 1, further comprising:
installing a natural frequency measurement system configured to quantify silicate uptake.

8. The method of upgrading the lumber vacuum-pressure impregnation process plant in claim 1, further comprising:
installing a multi-input solution dispensing system prior to feed lines into the vacuum pressure impregnation tank wherein the multi-input solution dispensing system is configured for formulation control, quantification, and delivering two or more impregnation charges.

9. The method of upgrading the lumber vacuum-pressure impregnation process plant in claim 1, further comprising:
installing a delivery system configured to dispense aqueous solutions of high, neutral, and low pH solutions before and after impregnation steps.

10. The method of upgrading the lumber vacuum-pressure impregnation process plant in claim 1, further comprising:
installing an immersion delivery system configured to dispense aqueous solutions of high, neutral, and low pH solutions before and after impregnation steps.

11. The method of upgrading the lumber vacuum-pressure impregnation process plant in claim 1, wherein at least one of the solutions is a high pH viscous solution.

12. The method of upgrading the lumber vacuum-pressure impregnation process plant in claim 6, wherein the hyper-spectral analyzer system for wood morphology analysis is arranged for use before and after impregnation.

13. The method of upgrading the lumber vacuum-pressure impregnation process plant in claim 1, further comprising:
installing an autoclave configured to handle the siliceous solution pressurized to at least 190 psi.

14. The method of upgrading the lumber vacuum-pressure impregnation process plant in claim 1, further comprising:
installing software for a controller configured to track, record, and analyze process variables for sodium silicate solutions, wherein the process variables include one or more of solution temperature, autoclave pressure, amounts of solution utilized, storage tanks temperatures, treatment autoclave temperatures, and duration of each stage of the process.

15. A plant to perform a lumber vacuum-pressure impregnation process, comprising:
timber handling equipment configured to transport timber from a receiving area to a plurality of stations, wherein the stations comprise:
a first vacuum pressure impregnation tank that is coupled to a first heated storage tank, a first blend tank, a first vacuum source, and delivery lines configured to handle high pH, viscous solutions between at least the first vacuum pressure impregnation tank and the heated storage tank;
at least one storage area;
a second vacuum pressure impregnation vessel that is coupled to a second heated storage tank, a second blend tank, a second vacuum source, and delivery lines configured to handle high pH, viscous solutions between at least the first vacuum pressure impregnation tank and the heated storage tank;
at least one CO₂ storage tank with an associated vaporizer and a CO₂ recovery system coupled to at least the first and second vacuum impregnation vessels;
at least one kiln;
at least labelling station;
at least one packing station; and
at least on shipping station;
a thermal management system comprising:
insulation and cladding on one or more of the vessels, tanks, and lines; and
heat tracing sensors; and
pumps configured to circulate solutions.

16. The plant to perform a lumber vacuum-pressure impregnation process of claim 15, further comprising:
an autoclave configured to handle a siliceous solution pressurized to at least 190 psi.

17. The plant to perform a lumber vacuum-pressure impregnation process of claim 15, further comprising:
a controller configured to track, record, and analyze process variables for sodium silicate solutions, wherein the process variables include one or more of solution temperature, autoclave pressure, amounts of solution utilized, storage tanks temperatures, treatment autoclave temperatures, and duration of each stage of the process.

18. The plant to perform a lumber vacuum-pressure impregnation process of claim 17, wherein the controller is a programmable logic controller.
